(19) United States
(12) Patent Application Publication
(10) Pub. No.: US 2026/0100124 A1
(43) Pub. Date: Apr. 9, 2026

(54) SMART ROAD STUDS

(71) Applicant: Itron, Inc., Liberty Lake, WA (US)

(72) Inventors: Premananda Sahoo, Bangalore (IN); Rahul Ranjan, Bangalore (IN); Ratnavel Subramanian, Bangalore (IN)

(21) Appl. No.: 18/908,529

(22) Filed: Oct. 7, 2024

(51) Int. Cl. G08G 1/01; G08G 1/04; G08G 1/042; G08G 1/056; G08G 1/07; G08G 1/16

(52) U.S. Cl. CPC G08G 1/0145; G08G 1/0116; G08G 1/07; G08G 1/16; G08G 1/04; G08G 1/042; G08G 1/056

(57) ABSTRACT

Techniques for determining information about an event by one or more devices proximate to a roadway are described herein. For example, a device (e.g., a smart road stud) may include an integrated proximity sensor which can detect a static vehicle or a static object on the road. The device may process the sensor data to determine an event type and an event location for events. In some examples, the device can identify other devices in a vicinity of the event (e.g., other smart road studs located on the road), and select devices for performing actions, such as re-routing traffic. In some examples, the device can send sensor data and/or other types of data to other devices, such as an adjacent smart road stud, an edge device, and/or a remote computing device.

### BACKGROUND

Currently, the real time detection of static objects on the road, such as broken-down vehicles or fallen trees, or other events is missing in the road safety system, which does not allow for information about the event to be conveyed to the on-coming traffic in a timely manner. This may lead to major accidents and vehicle pileups occurring on heavily used roadways. Further, an early warning mechanism for the affected area (e.g., the affected lane on the highway) due to accident is not in place.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. Moreover, the figures are intended to illustrate general concepts, and not to indicate required and/or necessary elements.

FIG. 1A is a block diagram showing an example environment in which an example device determines event data associated with an event.

FIG. 1B is a block diagram showing an example edge device.

FIG. 2 is a block diagram showing another example environment in which an example device implements the techniques described herein.

FIG. 3A is an example block diagram showing another example environment in which an example device implements the techniques described herein.

FIG. 3B is an example block diagram showing another example environment in which an example device implements the techniques described herein.

FIG. 4 is a flowchart depicting an example process for determining event data using one or more example components of an example device.

FIG. 5 is a flowchart depicting an example process for determining event data using one or more example components of an example device.

### DETAILED DESCRIPTION

### Overview

The disclosure describes techniques for determining information about an event occurring in an environment. For example, a device (e.g., a smart road stud, road stud sensor, etc.) may include an integrated proximity sensor which can detect a static vehicle or a static object (e.g., fallen tree, fallen pole, etc.) on the road. In some examples, the device can receive sensor data from one or more sensors coupled to the device located in the environment as a dynamic object moves through and/or stops in the environment. The techniques can include the device processing the sensor data to determine an event type and an event location for events. In some examples, the device can identify other devices in a vicinity of the event (e.g., other smart road studs located on the road), and select devices for performing actions, such as emitting notifications or messages to warn drivers or re-route traffic. In some cases, the sensor data can be transmitted to an edge device, such as a communication router, where the sensor data can be processed and/or sent to one or more central control servers (e.g., map servers, navigation servers, traffic control system, etc.) or distributed computing resource(s) (e.g., cloud service(s)) for further processing and/or routing.

In some examples, techniques include providing early indication or warning to on-coming traffic of a detected event. For example, the devices may have the capability to act upon a specific command and have the capability to blink or display light sources (e.g., integrated LEDs) in a certain pattern. In some cases, the devices may include a display unit where a message or other indicator can be displayed to the on-coming traffic. In some examples, such messages or other indicators can be determined and displayed automatically without input by a human or other traffic control systems. In some examples, the information can additionally or alternatively be communicated to a further system, such as a traffic control system. In some examples, the device may transmit the information to the further system and await instruction or approval from the further system (or a user thereof) prior to outputting the message or other indicator.

The device may, for example, configure messages for sending to another device (e.g., another smart road stud) in other locations of the environment based on the event type and the event location. The device may also receive and process additional sensor data from the other sensors to output different details regarding the event (e.g., change a color of the light source to a different color or a different pattern).

In some examples, the device may include a proximity sensor (e.g., passive infrared sensor (PIR), ultrasonic, inductive, light detection and ranging (lidar) sensor, radio detection and ranging (radar) sensor, etc.), a processing unit (e.g., microcontroller unit (MCU)), a light source (e.g., a programmable RGB LED), a radio frequency (RF) module (e.g., WiFi, Bluetooth, ZigBee, Cellular, NB-IoT, CAT M, LoRa, etc.), and a power supply (e.g., battery, capacitor, and/or solar panel). In some cases, the device may include other types of sensors, such as seismic sensor (e.g., different types of transducers for measuring motion such as resistive, capacitive, piezoelectric, optical, inductive, eddy current, linear variable differential transformer, etc.) to detect earthquake or any unusual vibrations.

The techniques described herein can incorporate a system that includes logic, algorithms, models, and/or the like to differentiate between objects located in an environment and a status of those objects (e.g., static or moving). For instance, the device can analyze sensor data from a variety of different sensor types in different locations to determine output data representing detailed information about the event. In some examples, the device can determine or identify other sensors from which to send messages based on the event type to ensure that the environments are safe (e.g., upstream smart road studs can blink the LEDs in a certain pattern, when the downstream smart road studs detect a large static object).

The techniques described herein can be implemented in a number of ways. Example implementations are provided below with reference to the following figures. Although discussed in the context of a streetlight operated by a utility service provider, the methods, apparatuses, and systems described herein can be applied to a variety of systems and is not limited to being coupled to a streetlight or used by utility systems. By way of example and not limitation, the techniques described herein may be implemented using devices and/or sensors disposed in, disposed on, coupled to, and/or part of a structure such as a streetlight, transformer, utility meter, manhole, fire hydrant, power pole, telephone pole, relay, traffic light, parking meter, building, bridge, overpass, street sign, charging station, bus stop, weather station, mailbox, collection bin (e.g., garbage, recycling, etc.), tree, or other structure in the environment. In some examples, the techniques can be utilized in a smart city, utility communication network, or in any system using sensor data. When the techniques are applied in the smart city, a device can be configured to exchange data with entities of the smart city to monitor, remedy, and/or reduce impact of an event.

### Example Systems and Techniques

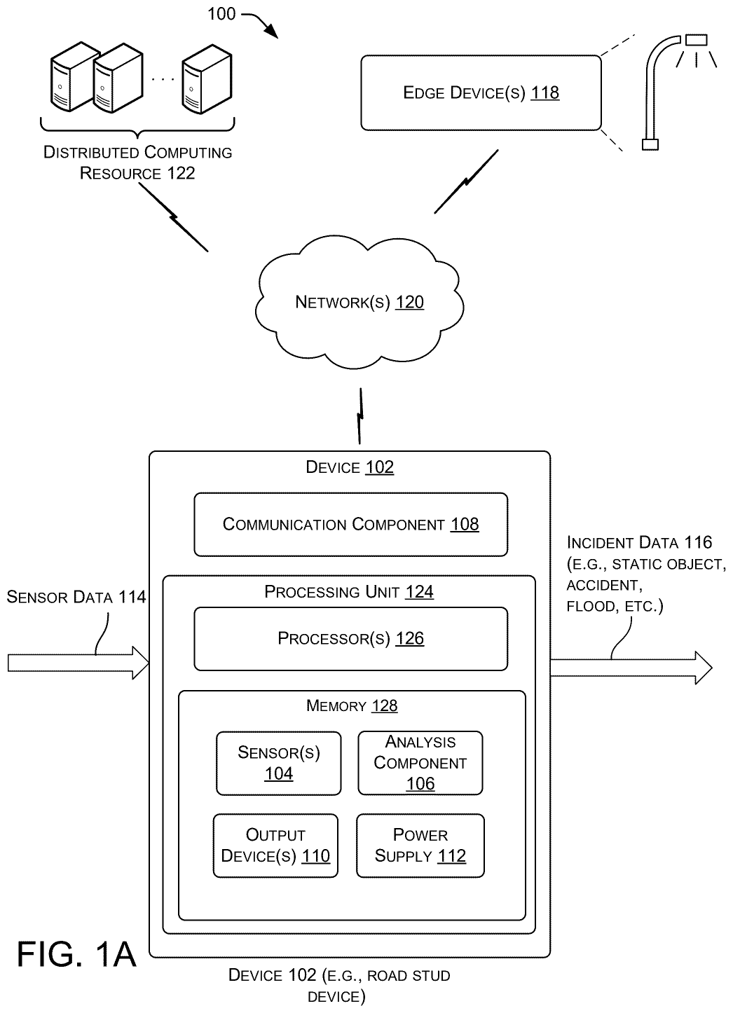

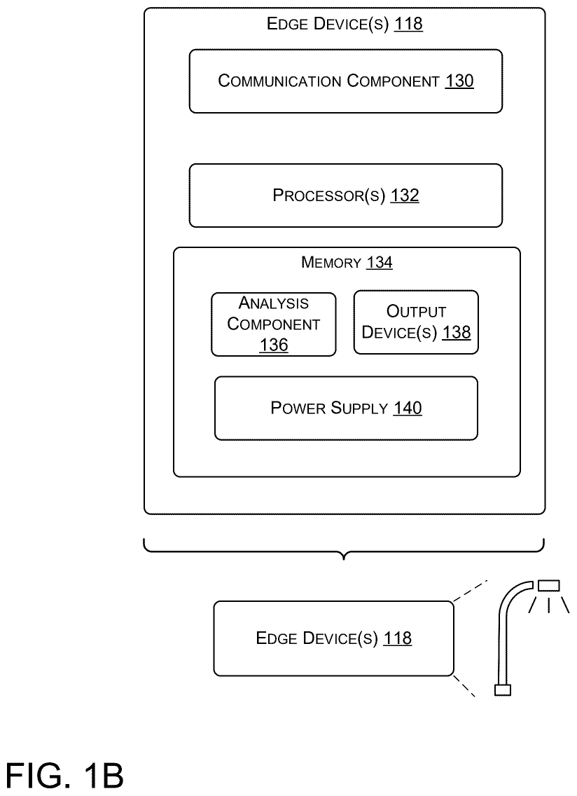

FIG. 1A is a block diagram showing an example environment 100 in which an example device (device 102) determines event data associated with an event. As shown in FIG. 1A, the device 102 includes a communication component 108, a processing unit 124 that includes one or more processor(s) 126 and one or more memor(ies) (shown as memory 128). The memory 128 includes sensor(s) 104, an analysis component 106, an output device 110, and a power supply 112.

The device 102 can include or otherwise represent software, firmware, and/or hardware for implementing the techniques described herein. Generally, the device 102 can represent functionality to detect presence of an event in the environment 100 such as a static object (e.g., a vehicle, a tree, a pole, etc.), weather event, an accident, a flood, an earthquake, and the like.

The processing unit 124 may represent an application-specific integrated circuit (ASIC), field programmable gate array (FPGA), general purpose microprocessor, microcontroller, system or PC on a chip/card, or other suitable hardware logic. The memory 128 may comprise computer-readable storage media that includes, but is not limited to, RAM, ROM, EEPROM, flash memory, cache memory, or other hardware storage devices or hardware-based memory technology.

The sensor(s) 104 can include one or more of: a microphone, a camera, a location sensor, a lidar sensor, a radar sensor, an infrared sensor, a gas sensor, an electrical sensor, a fluid sensor, a temperature sensor, a time-of-flight sensor, an ultrasonic sensor, and an inertial sensor (e.g., to detect theft, seismic activity, etc.), just to name a few. As mentioned, device 102 may be coupled to a variety of locations or structures including but not limited to: the surface of a road, a pole, a streetlight, a wall, a tunnel, a fire hydrant, a sign, an electrical distribution point, a gas conduit, a water conduit, a manhole, a storage tank (of water, gas, etc.), or another surface in the environment.

In some examples, the device 102 can represent an individual smart road stud integrated with an array of smart road studs located on a surface of a road, which forms a network of proximity sensors and by which a static object or a static vehicle on the road can be detected at any point on the road.

In various examples, the analysis component 106 can receive sensor data 114 (e.g., proximity data, audio data, image data, etc.) from the sensor(s) 104 as input to determine event data 116 describing an event in the environment 100. The system can then output information associated with the event to one or more other devices or services. In some examples, the analysis component 106 can implement statistical, mathematical, and/or machine-learned algorithms to determine whether the sensor data 114 is associated with an event affecting public safety such as a static object on the road, environmental impact, accident, and so on.

In some examples, the analysis component 106 can determine a type of event occurring at a particular time and monitor the event over a time period. For instance, the analysis component 106 can detect motion, audio, images, etc., indicative of a static object or vehicle accident by detecting, identifying, or otherwise determining one or more patterns in the motion, sound, and/or images associated with the sensor data 114. The analysis component 106 can, in some examples, identify a location of the event.

The analysis component 106 can identify another sensor at another location (e.g., upstream and/or downstream of the device 102 on the road) based on the type and/or location of the event. For example, based on the event type and distance from the sensor, the analysis component 106 can determine which other sensor types may be employed for gathering additional data specific for the type and/or location of the event. If the event includes a static object, for example, an additional device 102 at another location can be identified by the analysis component 106 to determine how long the object is on the road. In some examples, the communication component 108 can configure a message requesting sensor data from the other device 102. The message may request a desired orientation or resolution to improve detection of the event based on the event type.

The event data 116 determined by the analysis component 106 can describe the event based on sensor data from a single sensor or from multiple sensors. For example, an initial location determined by the device 102 (based on sensor data from the sensor(s) 104) can be modified based on receiving and processing the additional sensor data from one or more additional sensor devices at different locations. Thus, the event data 116 can indicate a more detailed location than the initial location determined by a single device. In examples when the event includes a flood, the analysis component 106 can identify which other locations near the event location can be used and generate a message(s) for transmitting to the available sensors proximate the event (e.g., additional water sensors to determine an area of the flood, a change in flood level over time, a water sensor to validate the occurrence of the flood, and so on).

In various examples, the analysis component 106 can determine magnitude and direction of a motion and/or sound and pick devices from which to receive additional sensor data that are located in a general direction of the motion and/or sound and at a distance based on the magnitude of motion and/or sound. In some examples, the analysis component 106 can determine a direction of travel of a person/object and then pick devices from which to receive additional sensor data that are located in the direction of travel. In some cases, the analysis component 106 may generate a predicted collision based on a motion data detected on the roadway. For instance, the analysis component 106 may determine that two or more vehicles are traveling towards one another at a speed in which a vehicle collision is likely. In this case, the analysis component 106 may send a message to the edge device 118 (e.g., an edge computing device), the central office 122, and/or an emergency provider indicating that a vehicle collision has been predicted.

The analysis component 106 can implement a variety of techniques to determine a refined location of the event. For example, the analysis component 106 can receive sensor data from multiple devices and analyze the sensor data to determine a refined event location (e.g., triangulation, looking at signal strength or magnitude of motion and/or sounds to determine relative proximity to the event, etc.).

The communication component 108 can provide functionality to enable the device 102 to communicate with another computing device, sensor device, a utility company central office (e.g., central office 122), and so on. The communication component 108 may be configured to format data, such as into frames or data packets associated with one or more communications protocols that facilitate one-way and/or two-way communication with entities external to the device 102. As an example, the communication component 108 may include a radio frequency (RF) transmitter, receiver and/or transceiver (not shown) to facilitate wireless communications, a power line communications (PLC) transceiver (not shown) for communication via a power line, a direct communication interface, etc.

In various examples, the communication component 108 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable current or future wired or wireless communications protocol that enables the device 102 to interface with the other computing device(s).

In some cases, messages may be transmitted between nearby devices 102 optically (e.g., one device blinks a message that could be detected by a nearby device to implement the navigation plan or other message). In some examples, the device 102 may utilize audible or ultrasonic sound waves (e.g., one device may emit sound that could be detected by a nearby device to implement the navigation plan or other message).

For instance, the communication component 108 may send at least a portion of the event data 116 to another device to communicate current information about the event and receive additional sensor data from the other sensor to refine or update the event data 116 over time. In some examples, the analysis component 106 can identify a device having a different modality than the device 102. Thus, the communication component 108 may be used to enable sensor devices located throughout an environment to exchange sensor data (or determinations therefrom) to dynamically detect events and determine which devices available in the environment to implement for gathering additional information about the event.

In some examples, the communication component 108 may send the event data to an edge device 118 (e.g., a pole mounted router (PMR), a connected grid router (CGR), a mains powered device (MPD) (i.e., powered by the electricity main as opposed to being battery powered), etc.) that may be coupled to an object (e.g., a streetlight, transformer, utility meter, manhole, fire hydrant, power pole, telephone pole, relay, traffic light, parking meter, building, bridge, overpass, street sign, charging station, bus stop, weather station, mailbox, collection bin (e.g., garbage, recycling, etc.), tree, or other structure in the environment) and configured with greater processing power than an individual device 102. In this case, the edge device 118 may be configured to communicate with a number of devices 102 and/or a whole array of devices 102 and received sensor data 114 and/or event data 116 from each of the devices 102. In some cases, the edge device 118 may be configured to make decision(s) as to which devices should output signals (e.g., blink LEDs, change color of LEDs, etc.) to execute a traffic pattern at and/or near the detected event. In some cases, the edge device 118 may send the sensor data 114 and/or the event data 116 to a central office 122 for further analysis. In some cases, the edge device 118 may send the sensor data 114 and/or the event data 116 to an electronic map or navigation server which in turn can be transmitted to on-coming traffic and/or devices accessing the MAP or navigation server. In this way, on-coming traffic can be diverted to avoid the affected segment of the road.

In some cases, the device 102 may be configured to make decision(s) as to which devices should output signals (e.g., blink LEDs, change color of LEDs, etc.) to execute a traffic pattern at and/or near the detected event. In some cases, the device 102 may send the sensor data 114 and/or the event data 116 to a MAP or navigation server which in turn can be transmitted to on-coming traffic and/or devices accessing the MAP or navigation server.

The output device(s) 110 can vary by location and can include a light(s) source for illuminating an area of the environment, a speaker(s) for emitting sound in the area, a display device to present text, an image, or a video, among others. In various example, the output device(s) at different locations can be coordinated to cause a sequence of light, sound, video, etc. for communicating a route to safety, or instructions to remedy the event.

The event data 116 from the device 102 can be used in a variety of ways. For instance, the communication component 108 may send at least a portion of the event data 116 to a storage device associated with the device 102 (at the location of the device 102 or at a remote location). The event data 116 may also or instead be sent over network(s) 120 to the edge device 118 and/or the central office 122 associated with the utility provider or an emergency provider. In such examples, the central office 122 may represent a headend device such as a server that manages sensor data and/or event data associated with a variety of locations.

In various examples, the analysis component 106 can control the output device(s) 110 based at least in part on the event data 116. For instance, a color, intensity, or other setting of a light can be modified to convey information associated with the event. Devices 102 at various locations can collectively output a sequence of light to indicate a path towards safety (e.g., a strobed or colored path to avoid a static object and/or an accident, for example). In examples when a speaker is included at the device 102, the analysis component 106 can generate different audio data for output by respective speakers to further communicate with people in the environment.

In some examples, the event data 116 may also or instead be transmitted by the communication component 108 to an emergency service such as a fire service, police service, etc. For example, the event data 116 may include details about a static object, an accident, or an emergency event to improve a response by the emergency service to remedy the event. Further, the communication component 108 can generate an instruction based on the event data 116 for sending to a traffic control device, streetlight, roadway marker, etc. to cause the traffic control device, streetlight, or roadway marker to provide a path for the emergency service to reach the location more efficiently (relative to not coordinating with other devices and sensors, for example). In this way, the communication component 108 can cause the traffic control device to notify a pedestrian or vehicle to avoid the location associated with the event.

In various examples, the device 102 can make an initial determination about an event and send the event data 116 and/or sensor data associated with one or more time periods to the edge device 118 and/or the central office 122, and receive a confirmation or verification from the edge device 118 and/or the central office 122 validating or overriding the initial determination by the device 102. For instance, the edge device 118 and/or the central office 122 may implement more sophisticated/powerful algorithms (than those implemented by the device 102) and/or utilize more information from additional devices (smart road studs, gas sensor, water sensor, electrical meter device, etc.) at other locations to either confirm or override the device's determination. For instance, the edge device 118 and/or the central office 122 may utilize information about a power grid (e.g., power surges, voltage fluctuations, data from other nearby meters and/or transformers, etc.), water grid, gas grid, etc. to either confirm or override the sensor device's determination.

In some examples, details about a particular event can be configured for output in a user interface on a display device. For instance, the analysis component 106 can correlate sensor data from various devices 102 with the event data 116, and a user or user device can request and receive information about an event (e.g., the analysis component 106 and/or the central office 122 receives a request for information about an event by time or location, or some other criteria). Event data can be configured to be human-understandable while also providing options or controls for the user to access additional detail as needed. For instance, a unique identifier can be used to access event data from a database or storage device for presentation on a map-based interface. The map-based interface can show detailed event information including, but not limited to, one or more of: the location of the devices on the map, types of sensor data collected at each location (e.g., motion, audio, image, temperature, etc.), the estimated location of the event (e.g., static object or vehicle, accident, etc.), the locations of any impacts (e.g., collisions, projectile impacts, etc.), locations of emergency personnel, and the like.

The network(s) 120 may represent various networks including public and/or proprietary utility company networks, the internet, a wired network, a wireless network, an optical network, and/or other network types.

FIG. 1B illustrates a schematic diagram of the edge device 118 and may include components configured to receive sensor data 114 and/or event data 116 and provide instructions to the devices 102. For instance, the edge device 118 and/or the central office 122 may include a communication component 130, that includes one or more processor(s) 132 and one or more memor(ies) 134. The memory 134 may include an analysis component 136 (the same or similar to the analysis component 106), an output device 138 (the same or similar to the output device 110), and a power supply 140 (the same or similar to the power supply 112). In some cases, the memory 134 may include other components as well, such as machine-learned model(s) and a data log component. The processing unit may represent an application-specific integrated circuit (ASIC), field programmable gate array (FPGA), general purpose microprocessor, microcontroller, system or PC on a chip/card, or other suitable hardware logic. The memory may comprise computer-readable storage media that includes, but is not limited to, RAM, ROM, EEPROM, flash memory, cache memory, or other hardware storage devices or hardware-based memory technology.

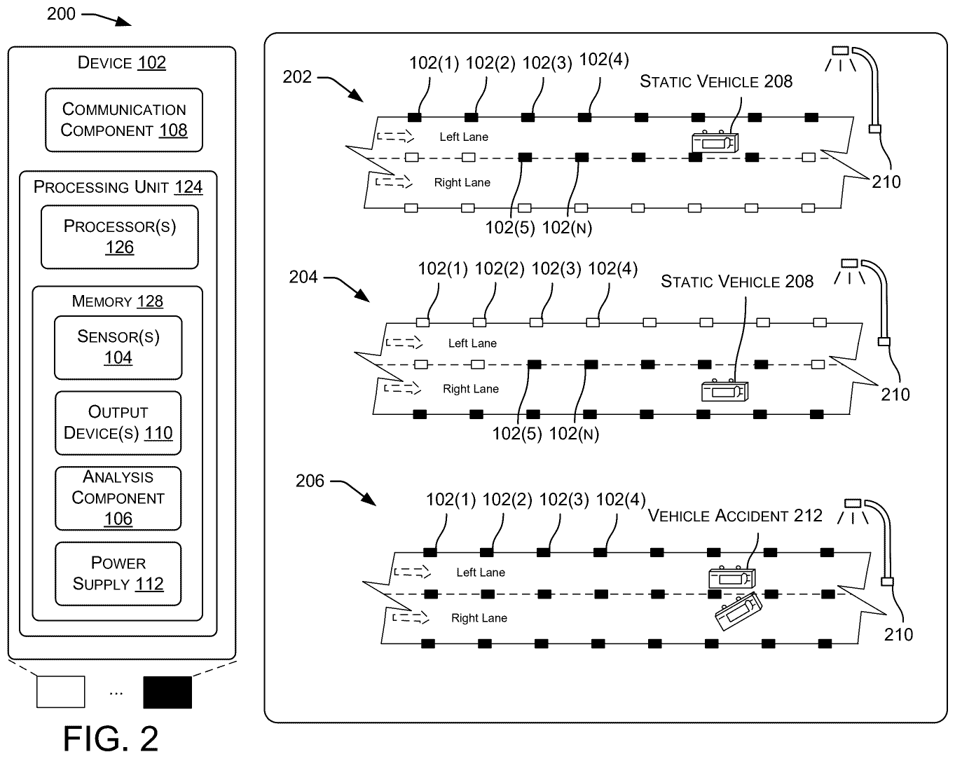

FIG. 2 is a block diagram of another example environment 200 in which an example device implements the techniques described herein. FIG. 2 shows the device 102 as illustrated in FIG. 1A. FIG. 2 further depicts a device 102(1), a device 102(2), a device 102(3), a device 102(4), a device 102(5), . . . , up to a device 102(N) where N is an integer (referred to collectively as the devices 102). FIG. 2 also depicts three different event scenarios, scenario 202, scenario 204, and scenario 206 in which a number of devices 102 (including device 102(1), a device 102(2), a device 102(3), a device 102(4), a device 102(5), and 102(N)) line the sides and middle of a road having a left lane and a right lane. Scenario 202 depicts a scenario in which a static vehicle 208 is detected in a left lane of a road. Scenario 204 depicts a scenario in which the static vehicle 208 is detected in the right lane of the road. Scenario 206 depicts a scenario in which the vehicle 208 has been involved in an accident with another vehicle.

Referring to scenario 202, here the devices 102 closest to the static vehicle 208 have detected that the static vehicle 208 on the left lane of the road has stopped moving. The sensor data (e.g., sensor data 114) from different devices 102 may be processed by each device 102 and sent to an edge device 210 (which may be the same or similar to the edge device 118 that is coupled to an object), where a determination may be made as to the type of event and instructions to be sent to the devices 102 that line the left lane and the right lane. In some cases, this may include sending a traffic pattern and/or navigational pattern (e.g., sometimes referred to as a navigation plan) to each device 102 located within an array of devices 102 proximate to the static vehicle 208. The traffic pattern and/or navigational pattern may include a color assignment for each device 102 within the array of devices 102, thereby implementing the traffic pattern and/or navigational pattern along the roadway. In other cases, the edge device 210 may generate a traffic pattern and/or navigational plan and may send instructions to the devices 102 including an indication of what color to display (e.g., red or green) based on referencing the traffic pattern and/or navigational plan as well as determining the location of each device 102 within the traffic pattern and/or navigational plan. In this case device 102(1), a device 102(2), a device 102(3), a device 102(4), a device 102(5), and 102(N) are instructed to turn red (represented in FIG. 2 by shading) indicating the left lane is blocked. Further, the devices 102 along the right lane outer boundary are instructed to turn green (represented in FIG. 2 by a lack of shading or white) which indicates that the right lane is open, and the vehicles can move to the right lane.

Referring to scenario 204, similar to the description of scenario 202, in this case the devices 102 closest to the static vehicle 208 have detected that the static vehicle 208 on the right lane of the road has stopped moving. Via communication with the edge device 210, as described with respect to scenario 202, in this case device 102(1), a device 102(2), a device 102(3), and a device 102(4), are instructed to turn green indicating the left lane is open. Further, the devices 102 (e.g., device 102(5) and 102(N)) along the right lane are instructed to turn red which indicates that the right lane is closed.

Referring to scenario 206, in this case the devices 102 closest to a vehicle accident 212 have detected that the vehicle accident 212 is blocking both the right lane and the left lane. Via communication with the edge device 210, as described with respect to scenario 202, in this case device 102(1), a device 102(2), a device 102(3), a device 102(4), a device 102(5), and 102(N), as well as all of the other devices 102 lining the left lane and the right lane, are instructed to turn red indicating that both the left and the right lane are blocked. Indicating, via the devices 102, that both the lanes are blocked could be information for the on-coming traffic to take precautionary action to slow down or stop the vehicle to avoid major accident and vehicle pile-up.

The analysis component 106 can, in various examples, monitor changes in the scenarios 202, 204, and 206 over time. For example, the analysis component 106 may receive real-time data (e.g., sensor data received from the sensors 104 each second or other timeframe), analyze the data and determine a type (e.g., classification, sub-classification) and location of the event (e.g., static vehicle 208 or vehicle accident 212). The event may represent an impact to public safety or any other of the examples described herein. In some examples, the analysis component 106 may analyze the data based on a machine learning decision tree, or other algorithm, that determines a type of the event (e.g., static vehicle, vehicle accident, type of weather event, etc.). Responsive to detecting the event, the analysis component 106 can generate messages for other sensor devices to cause the other sensor devices to generate additional sensor data associated with the event.

In various examples, the device 102 can combine sensor data from the additional devices to determine the event data output by the device 102. For example, the device 102 can receive sensor data from one or more other devices located along the roadway (e.g., device 102(1), a device 102(2), a device 102(3), a device 102(4), a device 102(5), and 102(N)) and implement one or more of the analysis component 106, the output device 110, and/or the communication component 108 to exchange sensor data and/or event data determined therefrom with the other devices along the roadway. In such examples, data from the other devices can be processed by the device 102 to output updated event data. For example, a sensor of a device located upstream or downstream from a particular device 102 can capture a different motion data of an object relative to the other location. The device 102 can process the motion data from the other device 102 to improve an initial determination (update the location of the event) and/or to determine a new attribute of the event (e.g., that the static vehicle has moved, or caught on fire, etc.).

In some examples, the analysis component 106 can determine a region associated with the event (e.g., location of the static vehicle 208 and/or the vehicle accident 212). For example, the analysis component 106 can define an area impacted by, or potentially impacted by, the event. In various examples, the region can represent a geofence or a proximity around the event. The analysis component 106 can, for example, define the region to include a boundary at a threshold distance from the event based on the event type, a direction of travel by an object, etc. A size or shape of the region can vary over time to reflect an area impacted by the event.

In some examples, the analysis component 106 can determine a threshold distance from the event based on an event type, a magnitude of a sensor signal, and/or a direction of the sensor signal. For example, the threshold distance from the event can vary according to a sensor type, the magnitude, and/or the direction associated with signals from the sensor.

The data output by the device 102 can be provided to a variety of computing devices including those associated with an emergency service provider, municipalities, or other entities responsible for public safety or environmental protection. That is, the device 102 can output event data based on detections from one or more sensors proximate the device 102 and/or event data based on detections from sensors associated with multiple devices located throughout the environment.

In some examples, the event data determined by the device 102 can be used to cause the output device 110 to change a setting or parameter of a light, speaker, and/or display. For example, multiple lights associated with different output devices 110 can be coordinated by the device 102 by sending messages with instructions for outputs specific for each light to collectively cause a sequence of lights that communicates to persons in the environment. Lights, can, for example, illuminate a route to safety, change color to indicate a direction of safety (e.g., red to green), turn on and off at different rates, or other type of light output.

While shown in FIG. 2 as a single block, processing unit 124 may be implemented as one or more separate devices and/or a parallel processing unit and is communicatively coupled to the memory 128. While shown as separate blocks, the sensor 104, analysis component 106, the communication component 108, output device 110, and/or the power supply 112 may be implemented as a single component or device and/or as multiple devices.

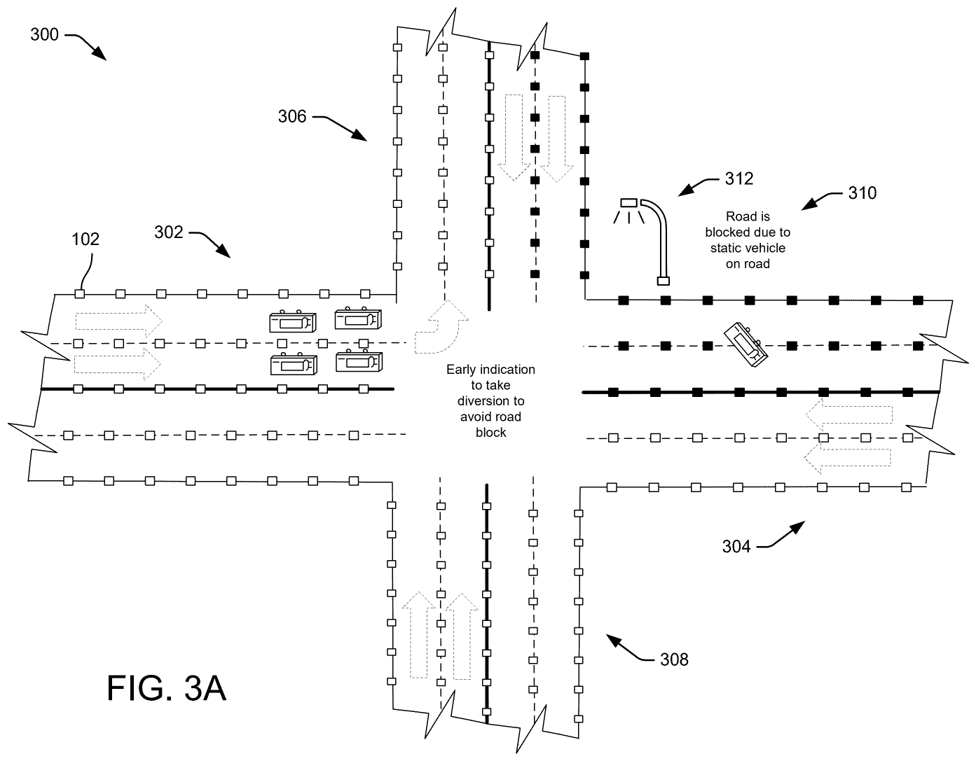

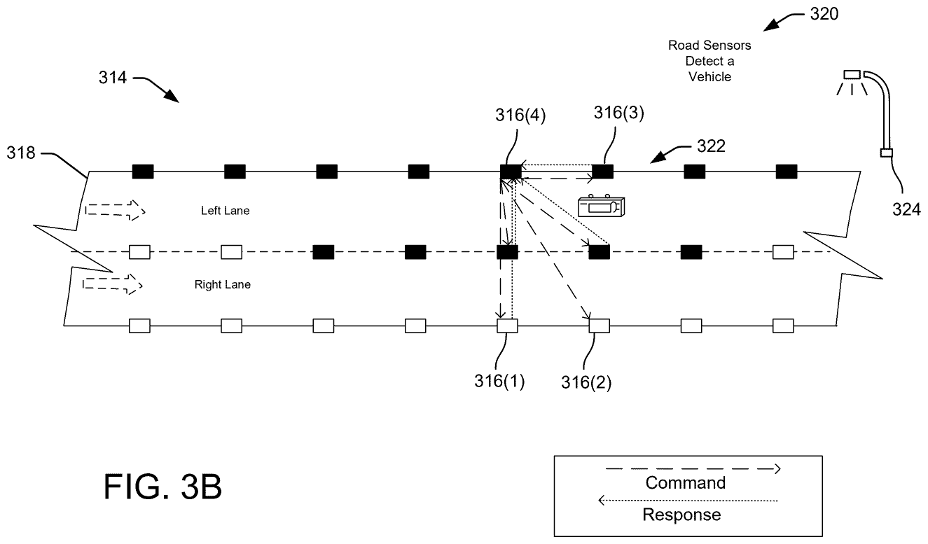

FIG. 3A is a block diagram of another example environment 300 in which an example device implements the techniques described herein. FIG. 3A shows a number of devices 102, as illustrated in FIG. 1A, located along roadway 302, roadway 304, roadway 306, and roadway 308. The environment 300 illustrates an event 310 in which both lanes of roadway 302 are blocked past an intersection. In this case, the devices 102 closest to the event 310 may detect that the roadway 302 is blocked and may determine an alternate route (e.g., traffic pattern and/or navigation pattern) for the vehicles traveling on roadway 302 to proceed. For example, the device 102 may send (e.g., via the communication component 108) event data to an edge device 312 that may be coupled to an object (e.g., a streetlight) and configured with greater processing power than an individual device 102. In this case, the edge device 312 may be configured to communicate with the array of devices 102 located along the roadways 302, 304, 306, and 308 and received sensor data and/or event data from each of the devices 102. In some cases, the edge device 312 may be configured to determine an alternate route for the vehicles traveling on the blocked road and make decision(s) as to which devices should output signals (e.g., blink LEDs, change color of LEDs, etc.) to execute a traffic pattern at and/or near the detected event in order to proceed on the alternate route. Once the traffic pattern is determined, the edge device 312 may send instructions to the devices 102 to execute the traffic pattern. In some cases, the edge device 312 may send the sensor data and/or the event data to a central office for further analysis and receive the alternate route (e.g., travel pattern and/or navigation pattern) from the central office and then forward instructions to execute the alternate route to the devices 102. In some cases, the edge device 312 may send the sensor data and/or the event data to a MAP or navigation server which in turn can be transmitted to on-coming traffic and/or devices accessing the MAP or navigation server. In this way, on-coming traffic can be diverted to avoid the affected segment of the road. For example, the edge device 312 may send instructions to the devices 102 along roadway 306 to turn green as an early indication to take a diversion to avoid the roadblock and the event 310. In some cases, the edge device 312 may send instructions to the devices 102 along roadway 302 that are past the intersection to turn red in order to indicate that vehicles should not enter roadway 302 past the intersection.

FIG. 3B is a block diagram of another example environment 314 in which an example device implements the techniques described herein. FIG. 3B shows a number of devices 316, as illustrated in FIG. 1A, located along roadway 318. The environment 314 illustrates an event 320 in which the devices 316 may make a local determination. For example, after detecting a static object 322 (e.g., a stalled vehicle) the device 316(4) may send sensor data to edge computing device 324 for further calculation and to make an appropriate decision. In some examples if the device 316(4) does not receive a response in a pre-defined time frame (e.g., 30 seconds, 1 minute, etc.), then the device 316(4) may initiate an algorithm to make a decision locally by communicating with nearby devices (e.g., device 316(1), device 316(2), device 316(3), etc.). In some cases, device 316(4) may act as a parent device and may send a command requesting sensor data from other nearby devices (e.g., device 316(1), device 316(2), device 316(3), etc.). After receiving the sensor data from other nearby devices, the parent device, device 316(4) may run an algorithm to determine and/or otherwise identify the static object 322 and make an appropriate decision. In some cases, after making the decision, the device 316(4) may send a command to devices in the network to display an LED in a certain pattern. In this case, the device 316(4) may act as an edge device. In some cases, the network of devices 316 with proximity sensor may provide real-time traffic density in a particular section of road and can be treated as an active traffic information system. The example in environment 314 illustrates a parent device requesting sensor data from other nearby devices, which may be referred to as “One-to-Many” communication. In other examples, the devices 316 may utilize “Many-to-Many” in which each of the devices 316 communicate with each other, as opposed to communicating with one singular device (e.g., device 316(4).

### Example Event Determination Method

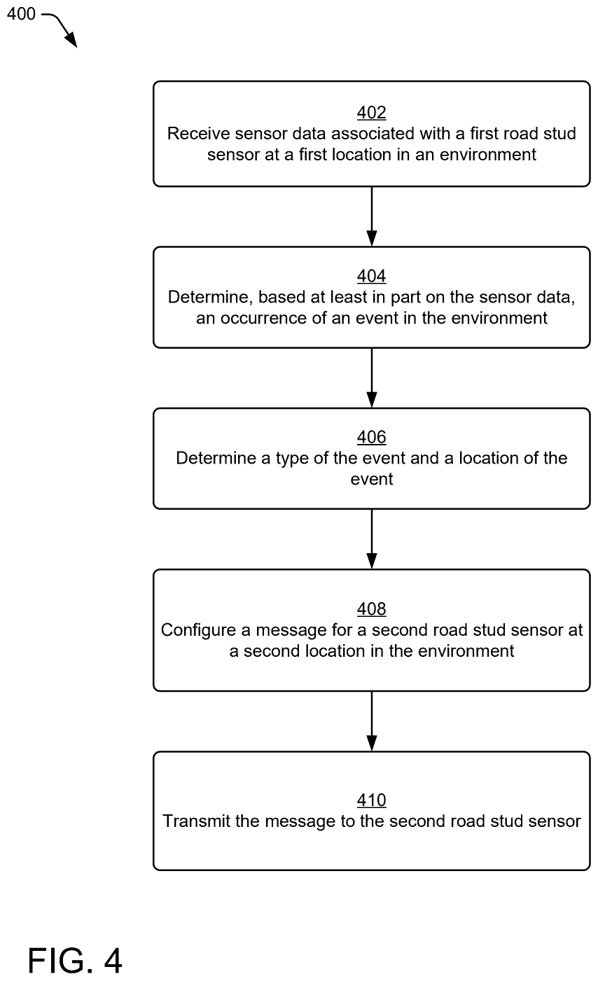

FIG. 4 is a flow diagram showing example process 400 which is representative of techniques for a device to detect and report events in an environment. The processes may, but need not necessarily, be implemented in whole or in part by or within the environment 100 and/or one or more of the devices of FIGS. 1 through 3. In the examples and techniques discussed herein, the methods of operation may be performed by one or more application-specific integrated circuits (ASICs) or may be performed by a general-purpose processor utilizing software defined in computer-readable media. In the examples and techniques discussed herein, the memory 128 may comprise computer-readable media and may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. The various algorithms, machine-learned models, logical expressions, functions, steps, and/or operations of the processes described herein may be encoded in computer-readable instructions, data structures, program modules, and/or other data to implement the various techniques described herein.

As defined herein, computer-readable media includes non-transitory computer-readable media as well as transitory media, such as modulated data signals and carrier waves, and/or signals.

FIG. 4 is a flowchart depicting an example process 400 for determining event data using one or more example components of an example device. The process 400 may be performed by the device 102, the edge device 118, the central office 122, and/or a combination thereof.

At operation 402, the process 400 may include receiving sensor data associated with a first road stud sensor at a first location in an environment. For example, the analysis component 106 can receive sensor data 114 (e.g., proximity data, audio data, image data, etc.) from the sensor(s) 104 as input to determine event data 116 describing an event in the environment 100.

At operation 404, the process 400 may include determining, based at least in part on the sensor data, an occurrence of an event in the environment. For example, the system can then output information associated with the event to one or more other devices or services. In some examples, the analysis component 106 can implement statistical, mathematical, and/or machine-learned algorithms to determine whether the sensor data 114 is associated with an event affecting public safety such as a static object on the road, environmental impact, accident, and so on.

At operation 406, the process 400 may include determining a type of the event and a location of the event. For example, the analysis component 106 can determine a type of event occurring at a particular time and monitor the event over a time period. For instance, the analysis component 106 can detect motion, audio, images, etc. indicative of a static object or vehicle accident by detecting, identifying, or otherwise determining one or more patterns in the motion, sound, and/or images associated with the sensor data 114. The analysis component 106 can, in some examples, identify a location of the event.

At operation 408, the process 400 may include configuring a message for a second road stud sensor at a second location in the environment. For example, the communication component 108 can provide functionality to enable the device 102 to communicate with another computing device, sensor device, a utility company central office (e.g., central office 122), and so on. The communication component 108 may be configured to format data, such as into frames or data packets associated with one or more communications protocols that facilitate one-way and/or two-way communication with entities external to the device 102. As an example, the communication component 108 may include a radio frequency (RF) transmitter, receiver and/or transceiver (not shown) to facilitate wireless communications, a power line communications (PLC) transceiver (not shown) for communication via a power line, a direct communication interface, etc.

At operation 410, the process 400 may include transmitting the message to the second road stud sensor. For example, communication component 108 may send the event data to an edge device 118 (e.g., a PMR, MPD, etc.) that may be coupled to an object (e.g., a streetlight) and configured with greater processing power than an individual device 102. In this case, the edge device 118 may be configured to communicate with a number of devices 102 and/or a whole array of devices 102 and received sensor data 114 and/or event data 116 from each of the devices 102. In some cases, the edge device 118 may be configured to make decision(s) as to which devices should output signals (e.g., blink LEDs, change color of LEDs, etc.) to execute a traffic pattern at and/or near the detected event. In some cases, the edge device 118 may send the sensor data 114 and/or the event data 116 to a central office 122 for further analysis. In some cases, the edge device 118 may send the sensor data 114 and/or the event data 116 to a MAP or navigation server which in turn can be transmitted to on-coming traffic and/or devices accessing the MAP or navigation server. In this way, on-coming traffic can be diverted to avoid the affected segment of the road.

In some cases, the device 102 may be configured to make decision(s) as to which devices should output signals (e.g., blink LEDs, change color of LEDs, etc.) to execute a traffic pattern at and/or near the detected event. In some cases, the device 102 may send the sensor data 114 and/or the event data 116 to a MAP or navigation server which in turn can be transmitted to on-coming traffic and/or devices accessing the MAP or navigation server.

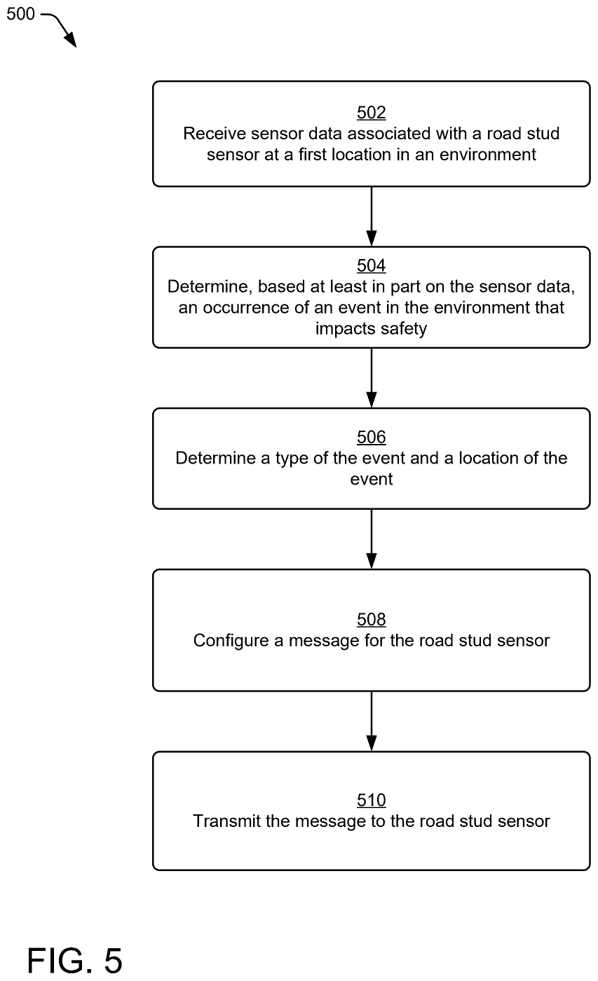

FIG. 5 is a flowchart depicting an example process 500 for determining event data using one or more example components of an example device. The process 500 may be performed by the device 102, the edge device 118, the central office 122, and/or a combination thereof.

At operation 502, the process 500 may include receiving sensor data associated with a road stud sensor at a first location in an environment. For example, the analysis component 106 can receive sensor data 114 (e.g., proximity data, audio data, image data, etc.) from the sensor(s) 104 as input to determine event data 116 describing an event in the environment 100.

At operation 504, the process 500 may include determining, based at least in part on the sensor data, an occurrence of an event in the environment that impacts safety. For example, the communication component 108 may send the event data to an edge device 118 (e.g., a PMR, MPD, etc.) that may be coupled to an object (e.g., a streetlight) and configured with greater processing power than an individual device 102.

At operation 506, the process 500 may include determining a type of the event and a location of the event. For example, the edge device 312 and/or a central office may be configured to communicate with the array of devices 102 located along the roadways 302, 304, 306, and 308 and received sensor data and/or event data from each of the devices 102.

At operation 508, the process 500 may include configuring a message for the road stud sensor. For example, the edge device 312 and/or a central office may be configured to determine an alternate route for the vehicles traveling on the blocked road and make decision(s) as to which devices should output signals (e.g., blink LEDs, change color of LEDs, etc.).

At operation 510, the process 500 may include transmitting the message to the road stud sensor. For example, messages may be transmitted via communication protocols discussed herein (e.g., via communication component 108 and/or communication component 130). For example, once the traffic pattern is determined, the edge device 312 and/or the central office may send instructions to the devices 102 to execute the traffic pattern.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some embodiments, one or more operations of the method may be omitted entirely. For example, the operation 408 may be omitted and sensor data can be received from one or more additional sensors automatically without sending a request to the additional sensor(s). Moreover, the methods described herein can be combined in whole or in part with each other or with other methods.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
receiving sensor data associated with a first road stud sensor at a first location in an environment;
determining, based at least in part on the sensor data, an occurrence of an event in the environment;
determining a type of the event and a location of the event;
configuring a message for a second road stud sensor at a second location in the environment; and
transmitting the message to the second road stud sensor.

2. The method of claim 1, wherein at least one of the first road stud sensor or the second road stud sensor comprises at least one of a passive infrared (PIR) sensor, an ultrasonic sensor, an inductive sensor, a lidar sensor, or a radar sensor.

3. The method of claim 1, wherein the message includes a navigation plan and an instruction to display a color based at least in part on the navigation plan.

4. The method of claim 3, wherein the navigation plan is configured to divert traffic away from the event.

5. The method of claim 1, wherein the first road stud sensor and the second road stud sensor are a part of an array of road stud sensors in the environment configurable to divert traffic via one or more light sources coupled to each of the road stud sensors.

6. The method of claim 1, further comprising sending the sensor data to an edge device configured to communicate with a distributed computing resource.

7. The method of claim 1, further comprising receiving, from an edge device, instructions for executing a navigation plan via at least one of the first road stud sensor or the second road stud sensor, wherein the navigation plan is configured to divert traffic away from the event.

8. One or more non-transitory computer-readable media storing instructions executable by one or more processors, wherein the instructions, when executed, cause the one or more processors to perform operations comprising:
receiving sensor data associated with a first road stud sensor at a first location in an environment;
determining, based at least in part on the sensor data, an occurrence of an event in the environment;
determining a type of the event and a location of the event;
configuring a message for a second road stud sensor at a second location in the environment; and
transmitting the message to the second road stud sensor.

9. The one or more non-transitory computer-readable media of claim 8, wherein the sensor data includes directional data and the event includes at least one of a predicted vehicle collision or a vehicle collision.

10. The one or more non-transitory computer-readable media of claim 8, wherein the sensor data indicates a presence of a static object and the event includes the static object blocking a road in the environment.

11. The one or more non-transitory computer-readable media of claim 8, wherein at least one of the first road stud sensor or the second road stud sensor comprises at least one of a passive infrared (PIR) sensor, an ultrasonic sensor, an inductive sensor, a lidar sensor, or a radar sensor.

12. The one or more non-transitory computer-readable media of claim 8, wherein the message includes a navigation plan and an instruction to display a color based at least in part on the navigation plan.

13. The one or more non-transitory computer-readable media of claim 8, wherein the first road stud sensor and the second road stud sensor are a part of an array of road stud sensors in the environment configurable to divert traffic via one or more light sources coupled to each of the road stud sensors.

14. The one or more non-transitory computer-readable media of claim 8, the operations further comprising sending the sensor data to an edge device configured to communicate with a central office server.

15. The one or more non-transitory computer-readable media of claim 8, the operations further comprising receiving, from an edge device, instructions for executing a navigation plan via at least one of the first road stud sensor or the second road stud sensor, wherein the navigation plan is configured to divert traffic away from the event.

16. A computing device, comprising:
one or more processors;
a communications component;
one or more non-transitory computer-readable media storing instructions executable by the one or more processors, wherein the instructions, when executed, cause the computing device to perform operations comprising:
receiving, via the communications component, sensor data associated with a road stud sensor at a first location in an environment;
determining, based at least in part on the sensor data, an occurrence of an event in the environment that impacts safety;
determining a type of the event and a location of the event;
configuring a message for the road stud sensor; and
transmitting, via the communications component, the message to the road stud sensor.

17. The computing device of claim 16, wherein the computing device is remotely located with respect to the road stud sensor.

18. The computing device of claim 16, wherein the sensor data is received from an edge device configured to communicate with the computing device and the road stud sensor.

19. The computing device of claim 16, further comprising transmitting the message to an array of road stud sensors in the environment configurable to divert traffic via one or more light sources coupled to each of the road stud sensors.

20. The computing device of claim 16, wherein the road stud sensor comprises a first road stud sensor and the computing device comprises a second road stud sensor.

21. A system comprising:
a computing device comprising one or more processors and one or more non-transitory computer-readable media; and
a road stud sensor communicatively coupled the road stud device, the road stud device configured to:
receive sensor data associated with an event at a location in an environment; and
send the sensor data to the computing device; and
wherein the computing device comprises instructions that, when executed by the one or more processors, configure the computing device to:
receive the sensor data;
determine, based at least in part on the sensor data, a type of the event at the location;
configure a message for the road stud sensor; and
transmit the message to the road stud sensor.

22. The system of claim 21, wherein the computing device comprises at least one of an edge device located in the environment or a distributed computing resource.

23. The system of claim 21, wherein the computing device comprises an edge device located in the environment and the message comprises a first message, the system further comprising a remote distributed resource configured to:
receive the sensor data from the computing device;
determine the type of the event at the location;
configure a second message for the edge device; and
transmit the second message to the edge device.

24. The system of claim 21, wherein the message includes a navigation plan and an instruction to display a color based at least in part on the navigation plan.

25. The system of claim 21, wherein the road stud sensor is a part of an array of road stud sensors in the environment configurable to divert traffic via one or more light sources coupled to each of the road stud sensors.
